(19) United States
(12) Patent Application Publication
(10) Pub. No.: US 2002/0032629 A1
(43) Pub. Date: Mar. 14, 2002

(54) Ranking-based screening system and method for equity analysis

(76) Inventors: John M. Siegel JR., Huntsville, AL (US); Fyodor N. Golos, Huntsville, AL (US)

Correspondence Address: LANIER FORD SHAVER & PAYNE, P O BOX 2087, HUNTSVILLE, AL, 35804, US

(21) Appl. No.: 09/843,252

(22) Filed: Apr. 26, 2001

Related U.S. Application Data
(60) Provisional application No. 60/199,868, filed on Apr. 26, 2000.

(51) Int. Cl. G06F 17/60

(52) U.S. Cl. 705/36

(57) ABSTRACT

A method of screening equities is disclosed. The method includes the steps of ranking a plurality of equity parameters to normalize each equity parameter with respect to each other equity parameter. User preferences respecting the weight to be given equity parameters of interest are received and the ranked equity parameters of interest are weighted based upon the received user preferences to assign each equity a score. A scored equity appropriate for the user preferences may then be selected. A system for screening equities is also disclosed.

### CROSS REFERENCE TO RELATED APPLICATION

This application claims the benefit of U.S. Provisional Application Ser. No. 60/199,868, filed Apr. 26, 2000 the entirety of which is incorporated by reference herein.

### BACKGROUND OF THE INVENTION

1. Field of the Invention

The present invention relates generally to equity screening, and more particularly, to computer-based parameter screening of a pool of equities.

While the present invention may be used in a number of environments, it is particularly well suited for use in a computer network environment, such as, but not limited to, the internet.

2. Technical Background

The generic term “equity screening” refers to a methodology by which a long list of equities is reduced to a smaller list of equities for further analysis. Equity screening is an essential tool for professional and independent investors since equity screening enables investors to wade through thousands of potential investment choices and return a more manageable list of equities for closer analysis.

A shortcoming associated with standard equity screening methods known in the art is that they require input that even experienced investment professionals would be hard-pressed to produce and the existence of screening results is not guaranteed. For example, a typical screening query might direct the user to input a desired price-to-earnings (“P/E”) ratio range (e.g., 15 to 35), a desired earnings growth rate range (e.g., 20% to 35%), and a desired average analyst rating range (e.g., strong buy—buy). This query may return anywhere from zero to thousands of equities and the usefulness of these results is somewhat questionable as arbitrarily changing some of these ranges or adding new screening parameters could completely change the results.

Given this and other shortcomings, it will be readily apparent to those of skill in the art that equity valuation is exceedingly complicated and difficult to use as different individuals have different levels of knowledge and experience in evaluating equities.

Thus there is a need for an improved screening method and system which allows an end-user to screen for equities in terms that are recognizable to the average investor. Such a system and method would return results based upon easily understood questions, such as:

Do you like high or low sentiment or do you not have a preference? (e.g., analysts' ratings)?

What market capitalization are you seeking (giant through micro) or do you not have a preference?

Do you like equities with a six-month price gain, loss, or do you not have a preference?

Do you like equities with a high or low valuation or do you not have a preference?

Do you like equities with a high or low earnings growth rate or do you not have a preference?

Would you like your above choices screened by market ranking, industry ranking, or both?

Do you have a minimum or maximum price range?

Additionally, there is a need for a system and method that can be customized to meet the needs of individuals having varying levels of skill in equity valuation. For example, an evaluation method may provide a user with the option to select from either a few parameters, several parameters, or numerous parameters. Moreover, there is a need for a system that provides several simplified interfaces between the user and the screening method so that a user may select from a multiplicity of interface configurations depending on the user's skill, needs, and desires. It is to the provision of such a system and method that the present invention is primarily directed.

### SUMMARY OF THE INVENTION

One aspect of the present invention relates to a method of screening equities. The method includes the steps of ranking a plurality of equity parameters to normalize each equity parameter with respect to each other equity parameter. User preferences respecting the weight to be given equity parameters of interest are received and the ranked equity parameters of interest are weighted based upon the received user preferences to assign each equity a score. At least one scored equity appropriate for the user preferences may then be selected.

An additional aspect of the present invention relates to a system for screening equities. The system includes a server system configured to receive equity parameters for a plurality of equities and user preferences respecting the weight to be given equity parameters of interest. A data base communicates with the server system to store the received equity parameters, and a central processing unit communicates with the data base to rank the received equity parameters in order to normalize each equity parameter with respect to each other equity parameter. The central processing unit is instructed to weight the ranked equity parameters of interest based upon the received user preferences in order to assign each equity a score and to select at least one scored equity appropriate for the user preferences.

Another aspect of the present invention relates to a method of equity screening which includes the steps of providing a pool of equities wherein equities have one or more parameters; obtaining parameter data for each parameter; assigning a parameter ranking to each parameter based on parameter data; selecting a weighting function for each parameter; assigning a score to each equity based on weighting function and parameter ranking; and sorting each equity based on each score.

In another aspect, the present invention is directed to a method of similar equity screening which includes the steps of selecting a target equity; providing a pool of equities wherein equities have one or more parameters; obtaining parameter data for each parameter; assigning a parameter ranking to each parameter based on parameter data; selecting a weighting function for each parameter based on a target equity; assigning a score to each equity based weighting function and parameter ranking; and sorting each equity based on each score.

Yet another aspect of the present invention relates to a method of displaying equity screening results. The method includes the steps of displaying a thumbnail ranking for fundamental categories; displaying a horizontal market median line; displaying a horizontal industry median line; displaying a vertical bar line for each fundamental category of equity screening analysis respective to market median; and displaying a vertical bar line for each fundamental category of equity screening analysis respective to industry median.

Stated generally, the present invention provides a methodology for screening equities through the use of various parameters. More particularly, this invention is directed to a multi-stage screening process in which: (1) each parameter of interest for each equity under consideration is assigned one or more ranking numbers (e.g., 0-10); (2) a weighting function is selected for each parameter; (3) a score is assigned to each equity under consideration using the ranked parameters in combination with the weighting functions for each parameter; (4) the list of equities under consideration is sorted in ascending (or descending) order based upon the scores; and (5) a reduced (screened) list of equities is created by selecting a number of equities with the highest (or lowest) scores from the global list of equities.

In accordance with the ranking-based screening system and method of the present invention, a user may choose to allow or disallow equities that do not lie within specified parameter ranges (e.g., disallow equities with a price-to-earnings ratio of greater than 25); or allow or disallow equities which are members of certain groups (e.g., industry/sector groups or equity groups, such as the S&P 500 or Dow).

In addition, a user may assign multiple rankings for each parameter (e.g., each parameter may be ranked by its position within the market as a whole each parameter may be ranked by its position within its own industry group).

As will be described in greater detail in the Detailed Description which follows, historical parameter data may be used in any of the embodiments of the present invention to, among other things, provide for back testing.

These and additional features and advantages of the invention will be set forth in the detailed description which follows, and in part will be readily apparent to those skilled in the art from that description or recognized by practicing the invention as described herein.

It is to be understood that both the foregoing general description and the following Detailed Description are merely exemplary of the invention and are intended to provide an overview or framework for understanding the nature and character of the invention as it is claimed. The accompanying drawings are included to provide further understanding of the invention and are incorporated in and constitute a part of this specification. The drawings illustrate various embodiments in the invention and together with the description serve to explain the principles and operation of the invention.

### BRIEF DESCRIPTION OF THE DRAWINGS

FIG. 1 is a flow chart illustrating an exemplary embodiment of the basic screening method in accordance with the present invention.

FIG. 2 is a schematic diagram illustrating an exemplary screening system in accordance with the present invention.

FIG. 3 is a flow chart illustrating an alternative embodiment of the basic screening method in accordance with the present invention.

FIG. 4 is a flow chart illustrating a screening method incorporating a data filter in accordance with the present invention.

FIG. 5 is a flow chart illustrating a screening method incorporating a group filter in accordance with the present invention.

FIG. 6 is a flow chart illustrating similar screening in accordance with the present invention.

FIG. 7 is a graphical representation of the market comparison results of the equity screening method of the present invention.

FIG. 8 is a graphical representation of the industry comparison results of the equity screening method of the present invention.

FIG. 9 is graphical representation of the thumbnail ranking results of the equity screening method of the present invention.

FIG. 10 is a graphical representation of a “quick” user input form in accordance with the present invention.

FIG. 11 is a graphical representation of a “standard” user input form in accordance with the present invention.

FIG. 12 is a graphical representation of an “advanced” user input form in accordance with the present invention.

FIG. 13 is a graphical representation of parameter screening options within an advanced screen in accordance with the present invention.

FIG. 14 is a graphical representation of a “similar screening” user input form in accordance with the present invention.

FIG. 15 is a typical “results” screen displayed by the equity screening method of the present invention.

### DETAILED DESCRIPTION OF THE PREFERRED EMBODIMENTS

One of the themes of the present invention is the concept that “everything is relative.” For example, the knowledge that a given equity has a price-to-earnings (P/E) ratio of 20 is not enough to make an informed judgment of the equity value. However, the knowledge that this P/E is around average for the market and is lower than 40% of the equities in a particular industry group under consideration puts the raw P/E figure in an improved perspective. The present invention preferably applies this relativity concept of ranking by market and/or ranking by industry to every parameter which is presented to a user of the present invention.

Ranking Generally

The general concept of ranking in accordance with the present invention provides for assigning one or more numbers to every parameter of every equity. For example, the first number could measure the value of the parameter for a given equity relative to the market, and the second number could represent the value of the parameter for a given equity relative to its respective industry. The purpose of ranking is to normalize the data set so that instead of comparing, for example, market capitalization (e.g., $10 billion) to price-to-earnings (e.g., 4), market capitalization rank is compared to price-to-earnings rank. The ranking process, therefore, puts these diverse parameters on common ground so that they can be compared to one another. Although not described in detail herein, ranking may also be performed with respect to exchange, membership, etc.

There are many methods for ranking equities. As defined herein, “ranking” includes the step of sorting followed by the step of normalizing. Thus, in a preferred embodiment, each equity parameter for a given equity parameter category (i.e., P/E) is sorted from high to low. For example, the highest value is assigned the number “10,” the lowest value is assigned the number “0,” and the values in between are assessed based upon their relative position in the sorted list. Generally speaking, this may be done using linear extrapolation or some other method commonly known in the art. A ranking is preferably provided for all equities within a market, thereby providing a “market” ranking and for all equities within an industry, thereby providing an “industry” ranking.

As those with skill in the art will recognize, ranking is in no way intended to be limited to the method discussed above. Ranking may also be carried out by determining the average value and the standard deviation for a given equity parameter within a list of equities, and assigning a normalized value according to the following equation:

$$normalized rank = \frac{\begin{matrix}\begin{matrix}[ parameter data - \\ ( average value of parameter for all equities ) ]\end{matrix}\end{matrix}}{( standard deviation of parameters for all equities )} \qquad Eqn . 1$$

Still another method of ranking would be to sort all values of a given parameter in ascending order and assign an index to each parameter based upon the respective position of the parameter in the sorted array (e.g., the index would be 1 for the lowest value in the list and the index would be the number of stocks under consideration for the highest value in the list). The rank may then be computed as:

$$Parameter {rank}_{equityi} = \frac{[ 10 * ( Parameter Sorted {Index}_{equityi} - 1 ) ]}{( number of stocks - 1 )} \qquad Eqn . 2$$

In accordance with industry ranking, the normalized data provided by the above described equations may only include equities within an appropriate industry group. For example, an “industry” ranking for a given data item can be assigned by applying the ranking method to each industry group within the larger market of all equities. The normalized data can then represent relative position in the industry groups, rather than the larger list of all equities in the market as a whole.

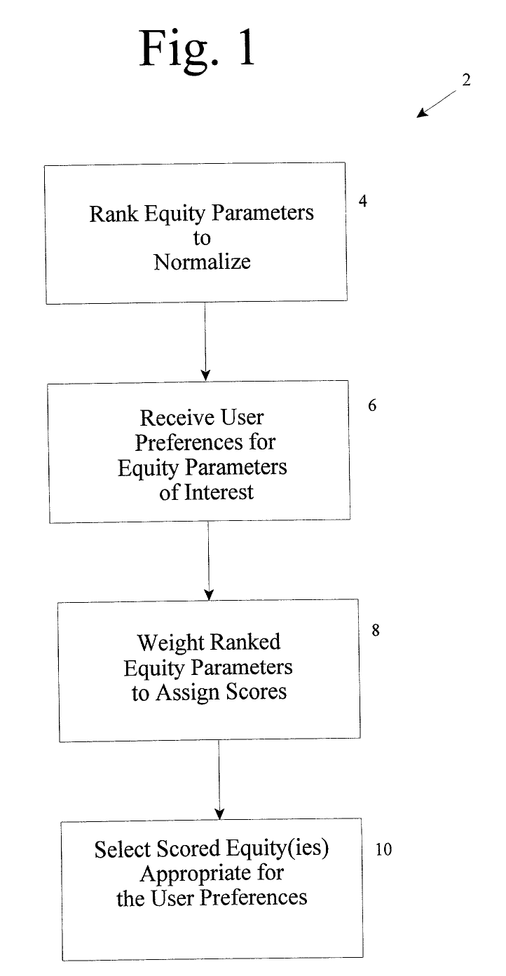

For the remainder of the detailed description it will be understood that rankings will be scaled from 0-10. Those skilled in the art will recognize that other ranking scales may be employed in accordance with the present invention. Reference will now be made in detail to the present preferred embodiments of the invention, examples of which are illustrated in the accompanying drawings. Wherever possible, the same reference numerals will be used throughout the drawing figures to refer to the same or like parts. As will be described in detail below, FIGS. 1-6 depict various embodiments of the present invention. An exemplary embodiment of the basic screening method of the present invention is shown in the flow chart depicted in FIG. 1, and is designated generally by reference numeral 2.

Screening

FIG. 1 depicts an exemplary embodiment of the basic screening method to the present invention. In step 4, a plurality of equity parameters are ranked to normalize each equity parameter with respect to each other equity parameter. In step 6, user preferences are received respecting the weight to be given equity parameters of interest. In step 8, the ranked equity parameters of interest are weighted based upon the received user preferences to assign each equity a score. Thereafter in step 10, at least one scored equity appropriate for the user preferences is selected.

In accordance with the basic screening method of the present invention, a plurality of equity parameters for each equity in a pool of equities are received and sorted by category (i.e. P/E, ROE, etc.) according to each equity parameter's value. Generally speaking, the equity parameter values are sorted from high to low within each equity parameter category, but other sorting criteria may also be used. Each equity value parameter is then normalized, preferably by assigning each a value from 0 to 10 as discussed above. Typically, two values will be assigned to each equity parameter; a market rank, and an industry rank.

One or more user preferences for one or more equity parameters of interest are then received which provide information relating to the weight given each equity parameter of interest. By way of example, a preference indicating that the user would like to be provided with a list of equities having low P/E, market only may be received. Based upon this information, a weighting function such as [score=weight (market rank)] where [market rank=(10−market rank)] may be applied to the ranked equity parameters of interest. Such a weighting function will be applied to all equities in the pool of equities to assign each equity a score. These scores may then be sorted, preferably from high to low, and one or more equities having a score most representative of the received user preferences (low P/E, market only) will be selected. The one or more equities and their scores may then be provided to the user in satisfaction of his or her request.

Generally speaking, the available user preferences may include a mechanism for selecting the number of results the user wants returned in response to its request. For example, the user may request only one equity meeting its criteria, in which case, the equity having the highest or lowest score (depending upon the user's preference) will be returned. Similarly, the user may request a list of 10 equities having scores most relevant to the user preferences. In yet another aspect, the user may indicate that he or she would like the default list which may include a list of 32 or more relevant equities.

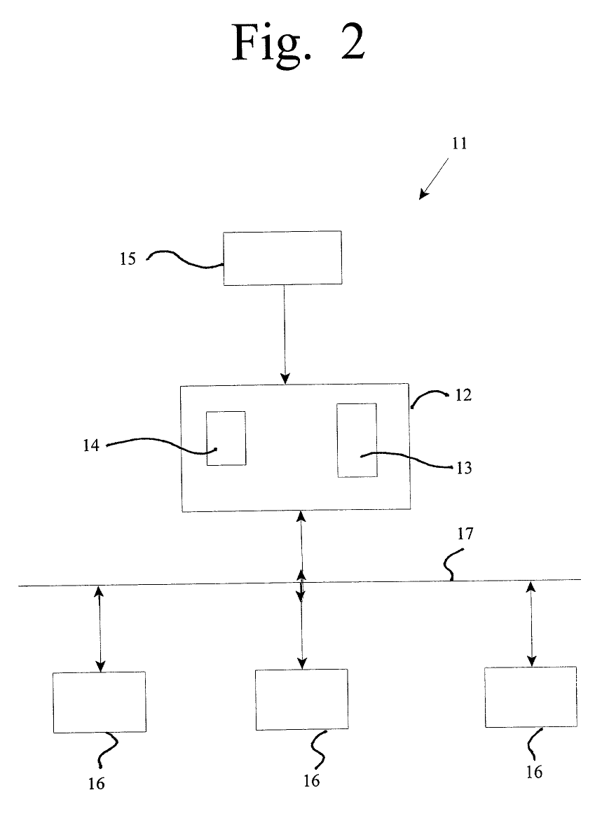

FIG. 2 depicts a system 11 for screening equities in accordance with the present invention. As shown in FIG. 2, system 11 includes a server 12 configured to receive equity parameters for a plurality of equities, and user preferences respecting the weight to be given the equity parameters of interest. System 11 includes a database 13 that communicates with the server system to store the received equity parameters. Database 13 may be used to store updated equity parameter data as well as historical equity parameter data. A central processing unit 14 communicates with the database to rank the received equity parameters in order to normalize each equity parameter with respect to each other equity parameter. Central processing unit 14 is instructed to weight the ranked equity parameters of interest based upon the received user preferences in order to assign each equity a score. Central processing unit 14 is further configured to score and to select at least one scored equity appropriate for the user's preferences.

In operation, server system 12 communicates with and receives equity parameters from a source 15 of equity data including, a pool of equities each having associated therewith a plurality of equity parameters. The data may be received through any network connection such as a local area network (LAN), a wide area network (WAN), land-line, a wireless connection, etc. Likewise, user preferences, such as those discussed above with respect to method 2 of the present invention may be received from one or more remote computers 16 or other devices capable of providing a user interface compatible with server system 12. As shown in FIG. 2, computers 16 preferably communicate with server system 12 via network connection 17.

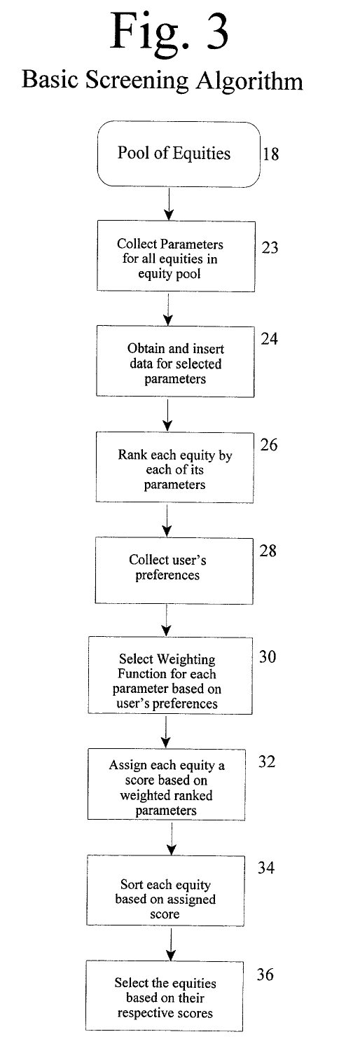

Further details and additional aspects of method 2 and system 11 of the present invention will be described below in the remainder of the detailed description and accompanying drawing figures. Unlike the method depicted in FIG. 2, FIGS. 3-6 depict alternative embodiments of the method of the present invention which allow for ranking of less than all of the available equity parameters and/or the step of ranking, “on-the-fly.”

FIG. 3 depicts an alternative basic screening algorithm. In step 18, a pool of equities is provided or generated. The equities and associated parameters are preferably stored in one or more databases for multiple periods of time. These databases allow for substantially real-time equity screening analysis and historical analysis. Each equity has certain parameters, and a combination of all the parameters is collected in step 23. For example, the parameters could include price-to-earnings ratio (“P/E”), valuation, most recent moving-average convergence-divergence (“MACD”), return on equity (“ROE”), average analyst rating, growth rate, etc. In step 24, data is obtained for each of the parameters. The term “data” refers to any quantitative descriptor of a given equity.

In step 26, each equity is then ranked against the other equities for each parameter based on parameter data (or the ranking may be queried from a database that stores ranking results from previously-performed rankings). Again, ranking encompasses any method which may be used to normalize each equity parameter from a list of equities such that the normalized values for each equity parameter will have the same order of magnitude as the normalized values for all other parameter data.

In step 28, the user's preferences are collected, and in step 30, a weighting function is selected for each parameter based on the user's preferences. For example, if the equities are ranked from 0 to 10 and it is desired to find equities with the best blend of a low P/E and a high ROE (return on equity), then an appropriate weight function for P/E could be:

Weight_{P/E}=10−(P/E rank) “good when high” Eqn.3

and an appropriate weight function for ROE could be:

Weight_{ROE}=(ROE rank) “good when low” Eqn.4

In step 32, a score is then assigned to each equity based on the weighted rankings for the parameters. For example:

Score=weight_{P/E Rank}(P/E Rank_{equity})+weight_{ROE}(ROE_{equity}) Eqn.5

In general, the formula used to determine each equity's score is as follows:

$$Score = {\sum }_{i = 1}^{n} {weight}_{i} ( {Rank}_{i} ) \qquad Eqn . 6$$

where n=the number of parameters and i represents each parameter. The user may select the desired number of equities in the final list of equities meeting the user preferences, as well as determine whether the ranking is within industry, market, or both.

In step 34, the equities are sorted based on the assigned score, and in step 36, the relevant equities are selected based on weighted rankings. For example, the top ten equities could be listed, or a single equity may be requested. It will be understood that the weighting and ranking functions can be applied to market, industry and/or other market qualifiers.

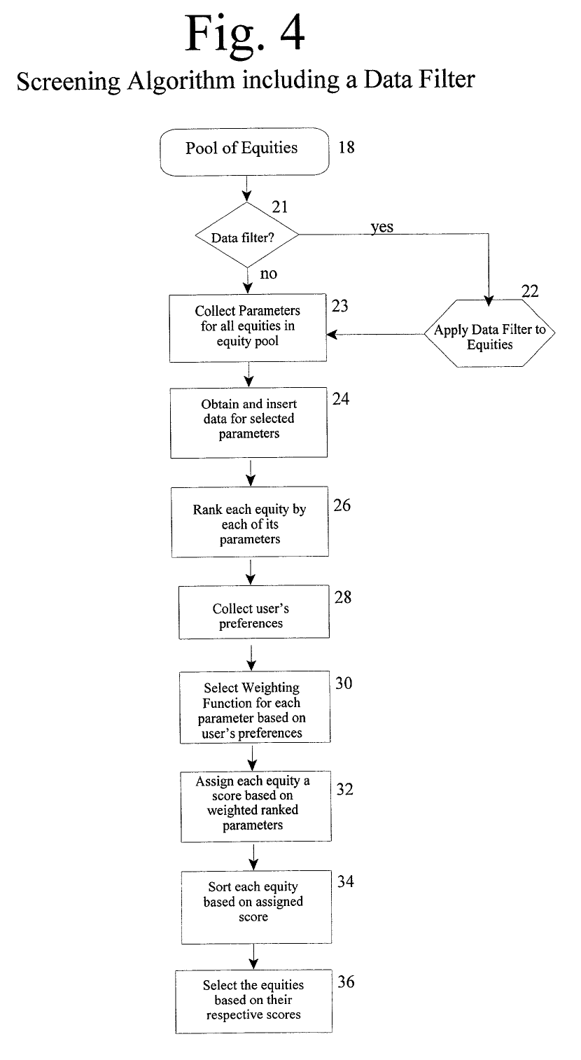

FIG. 4 depicts a basic screening algorithm that includes a data filter, an embodiment of the present invention in which a data filter is used. A data filter is used to remove certain equities from the available pool of equities based upon the value of a parameter (e.g., the returned stocks must have a maximum P/E ratio of 20). In step 21, a determination is made as to whether or not a data filter has been selected by a user. If yes, in step 22, the data filter is applied, i.e., the data filter removes equities that fail to satisfy the specified requirements from the initial pool of equities. A filter may remove any equity from the pool that contains data items outside of the specified range. The remaining steps (18, 23, 24, 26, 28, 30, 32, 34, and 36) are the same as those of the embodiment shown in FIG. 3.

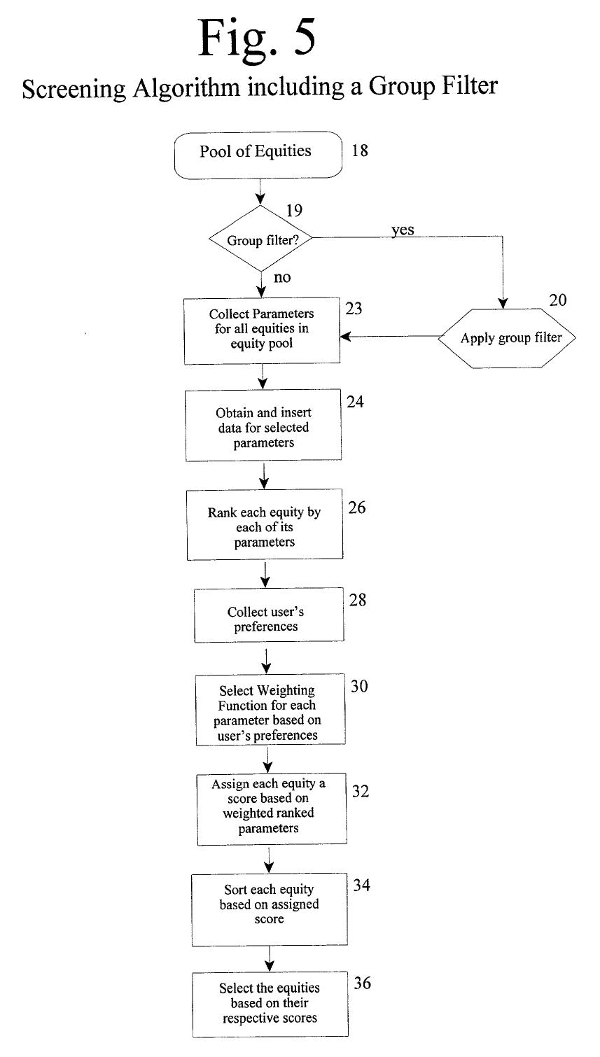

FIG. 5 depicts an alternative embodiment of the present invention in which a group filter may be used. Group filters are used to include/exclude equities from the available pool based upon membership or non-membership in specified groups (e.g., member of Dow or not a member of the telecommunications group). In step 19, it is determined whether or not a group filter preference has been selected by a user. If yes, in step 20, the group filter is applied, i.e., the group filter removes equities that are or are not members of certain groups. The remaining steps, (18, 23, 24, 26, 28, 30, 32, 34, and 36) are the same as those of the embodiment shown in FIG. 4.

It will be apparent to one skilled in the art that the various embodiments of the present invention, provide the following functionality:

1. The pool of equities can come from any source. For example, the pool may come from mutual funds, commodities, and the like, as well as equities.

2. The parameters under consideration can be any parameter in which ranking can be performed, for example, valuation, price change, and the like.

3. The ranking of each parameter can be obtained by any methodology, for example, standard deviation, historical changes in the parameters, etc.

4. Any weighting function can be used to obtain the desired emphasis upon the various user input parameters.

5. The assembled score can be calculated through any appropriate combination of the ranking and weighting steps.

6. The method of the present invention may use maximums, minimums and/or combinations thereof.

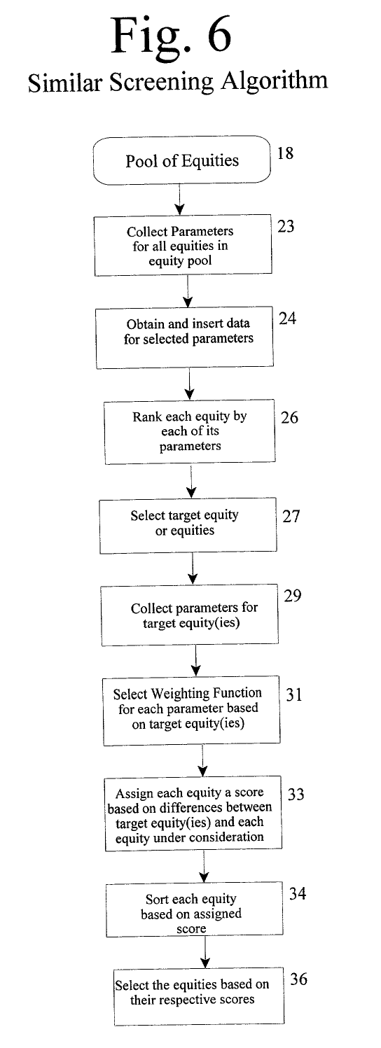

FIG. 6 depicts an alternative embodiment of the present invention in which a target equity is the selected user parameter. This method will be referred to as Similar Screening. A target equity (or equities) is selected in step 27. All parameters are collected for the target equity(ies) in step 29. The weighting function for each parameter is then selected based on the target equity or equities (in step 31). Each equity is assigned a score based on the differences between target equity(ies) and each equity under consideration. (Steps 18, 23, 24, 26, 34, and 36 are the same as those of the embodiment shown in FIG. 3.) Target equities may be selected based upon positive past performance, desirability of the industry group, or any other criteria which the user specifies.

Similar Screening can assist portfolio management since algorithms for locating similar equities allow a portfolio manager to determine which equities are attractive to a given client, based upon the current holdings in the client's portfolio. Another application of this technology is to find equities which are similar to an equity which has had historically good returns. For example, one could search for equities similar to Microsoft, Dell, and/or Cisco.

Similar equities are equities, which have small differences between the rankings of all equity parameters under consideration. The “small” or “large” differences are determined through a ranking process. A weighting function reflects the difference between the rankings for a given equity and a target equity or equities.

For example, consider the problem of finding equities within the NASDAQ which are similar to Microsoft, based upon P/E ratio and six-month gain. As with the basic screening embodiments of the present invention, P/E ratio and six-month price gain (“6MPG”) are assembled and ranked for all equities within the NASDAQ. A data filter, as shown in FIG. 4, or a group filter, as shown in FIG. 5, could alternatively be used. In step 31 of FIG. 6, a weighting function is selected for each parameter based on the target equity. The weighting is applied to the P/E rank of all equities giving:

An example weighting function for P/E rank:

Weight_{P/E,equity}(Rank_{P/E,equity,}Rank_{P/E,Target})=10−ABS(Rank_{P/E,equity}−Rank_{P/E,Target}) Eqn.7

An identical weighting function for 6 month price gain (6MPG):

Weight_{6MPG,equity}(Rank_{6MPG,equity},Rank_{6MPG,Target})=10−ABS(Rank_{6MPG,equjty}−Rank_{6MPG,Target}) Eqn.8

The aggregate score is then:

Score_{equity}=Weight_{P/E,equity}(Rank_{P/E,equity,}Rank_{P/E,Target})+Weight_{6MPG,equity}(Rank_{6MPG,equity},Rank_{6MPG,Target})=10−ABS(Rank_{P/E,equity}−Rank_{P/E,Target})+10−ABS(Rank_{6MPG,equity}−Rank_{6MPG,Target}) Eqn.9

The score for n parameters is then:

$${Score}_{equity} = {\sum }_{i = 1}^{n} {Weight}_{i , equity} ( {Rank}_{i , equity} , {Rank}_{i , Target} ) \qquad Eqn . 10$$

Or using the weighting function in the preferred embodiment:

$${Score}_{equity} = {\sum }_{i = 1}^{n} 10 - ABS ( {Rank}_{i , equity} - {Rank}_{i , Target} ) \qquad Eqn . 11$$

One way of dealing with multiple targets is to use the average ranking for the target:

$${Score}_{equity} = {\sum }_{i = 1}^{n} {Weight}_{i , equity} ( {Rank}_{i , equity} , {Rank}_{i , average target} ) \qquad Eqn . 12$$

In the preferred embodiment, this then becomes:

$${Score}_{equity} = {\sum }_{i = 1}^{n} 10 - ABS ( {Rank}_{i , equity} - {Rank}_{i , averaget target} ) \qquad Eqn . 13$$

A particularly useful feature of this embodiment of the present invention is that historical data screening can be used to answer a variety of questions. Historical data can be used for the target equities and/or the list of equities under consideration. This creates a 2×2 matrix of screen configurations of:

$$[ \begin{matrix}\{ current target , current list \} & \{ current target , historical list \} \\ \{ historical target , current list \} & \{ historical target , historical list \}\end{matrix} ] \qquad Eqn . 14$$

where:

current target, current list is a screen for equities which are currently similar to a given equity or portfolio;

current target, historical list compares how equities which were in the past similar to the current target have performed over the historical period, which is similar to back-testing;

historical target, current list finds equities which are currently similar to a given equity in the past (perhaps this equity has a high price gain/loss over the historical period and the user is seeking equities which today might match this profile); and

historical target, historical list is back-testing of the current target, current screen list.

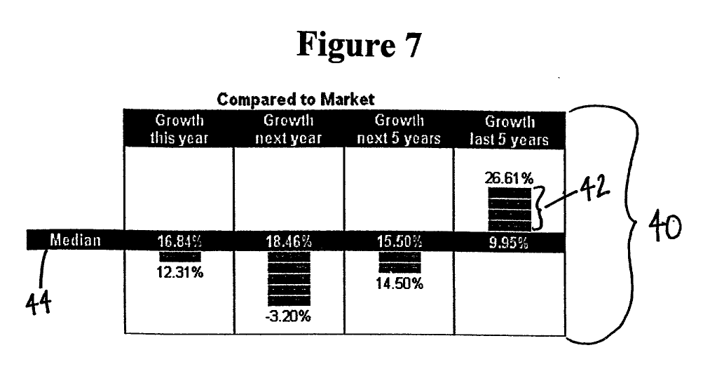

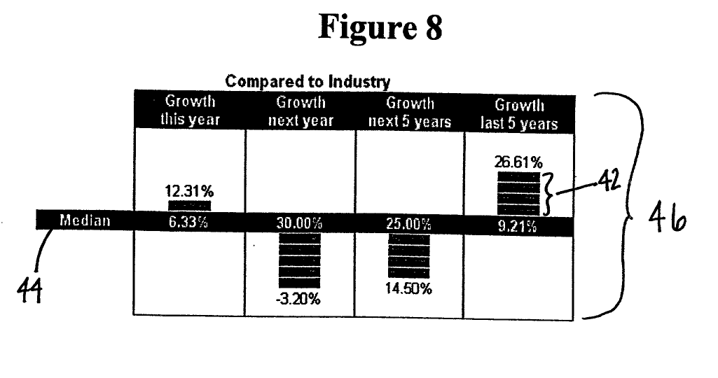

An additional feature of the present invention, as shown in FIGS. 7-9, is the ability to graphically represent the results of the equity screening. In the graph 40 shown in FIG. 7, ranking bars 42, which are preferably represented in color, facilitate quick review of a given equity within the market as a whole and, in the graph 46 shown in FIG. 8, the bars 42 facilitate a quick review of a given equity within its listed industry group. These bars are provided for such fundamental parameters as Profile, Profitability, Earnings, Ratios, Valuation, and Sentiment. The middle section of the bar 44 represents the median value of a parameter. As defined, fifty percent of the equities are below the median and fifty percent of the equities are above the median. If the bar is above the median line, then the equity has a higher rank for this parameter than the median. Bars below the median line have a lower rank than the median.

Preferably, the height and color of the bars are relative to how far a given equity is above or below the median. For example, the top 10% of equities will have a tall green bar above the median. The bottom 10% will have a tall red bar below the median.

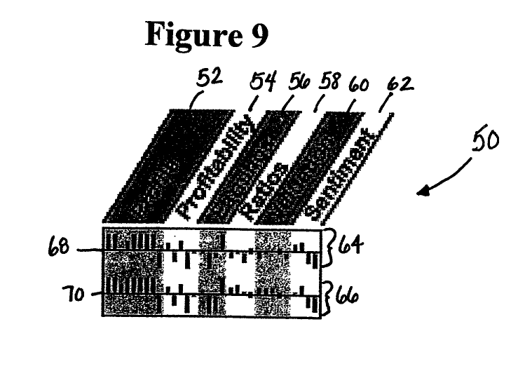

As depicted in FIG. 9, an additional feature of the present invention is thumbnail ranking. Thumbnail ranking images 50 provide a method for displaying a multitude of parameters such that an overview of a given equity is provided at a glance.

In a preferred embodiment, the thumbnails are divided into six sections by alternating gray and white background colors. These six sections represent the six fundamental categories: Profile 52, Profitability 54, Earnings 56, Ratios 58, Valuation 60, and Sentiment 62, respectively. The top section 64 of each image represents the market rankings while the lower section 66 of each image represents the industry rankings. Additionally, the upper black line 68 on the image is the market median; the lower black line 70 is the industry median. The preferably colored ranking bars facilitate quick review of a given equity within the market as a whole as well as a quick review of a given equity within its listed industry group. Again, the middle section represents the median value of a parameter. As defined, fifty percent of the equities are below the median and fifty percent of the equities are above the median. If the bar is above the median line, then the equity has a higher rank for this parameter than the median. Bars below the median line have a lower rank than the median. Preferably, the height and color of the bars are relative to how far a given equity is above or below the median. For example, the top 10% of equities will have a tall green bar above the median. The bottom 10% will have a tall red bar below the median.

This allows an individual reviewing the thumbnails to make a quick observation regarding the ranking of the collective displayed parameters, thereby assisting in evaluating the value of the equity. The frequency and height of the red bars correlate to a lower value. Conversely, the frequency and height of the green bars correlate to a higher value. Additionally, as these are thumbnails, it expedites the comparison of multiple equities in a single view.

Set forth below is a brief summary and explanation of the six fundamental categories provided by the graphical representations depicted in FIGS. 7-9: Profile, Profitability, Earnings, Ratios, Valuation, and Sentiment.

Profile

The profile category of parameters can provide a quick overview of a particular equity, including average volume, number of shares, and market capitalization. Examples of specific equity parameters are as follows:

| | |
|---|---|
| Average | Average trading volume for the last 3 months, expressed in |
| Volume | millions of shares. |
| Shares | Shares outstanding, expressed in millions of shares |
| | outstanding in the most recent quarter. |
| Beta | 36-month beta: Beta is a coefficient which measures the |
| | volatility of an equity's returns relative to the market. In the |
| | present invention the S&P 500 is a preferred market. |
| Dividend | Dividend Payout: Dividend payout equals the fiscal |
| | dividend per share divided by the fiscal EPS (earnings per |
| | share), expressed as a percentage. The percentage indicates |
| | the percent of EPS that was paid out as a dividend. |
| Earnings | Total earnings, expressed in millions from the latest 12 |
| | months. |
| Sales | Total sales, expressed in millions from the latest 12 months. |
| Book | Total book value, expressed in millions for the most recent |
| | quarter. |
| Market | The most recent price of the shares outstanding. |
| Capitali- | |
| zation | |
| Cash | Total cash, expressed in millions for the latest 12 months. |

Profitability

The profitability parameters indicate profitability and health of a business and include return on assets and profit margin. Examples of specific equity pararmeters are as follows:

| | |
|---|---|
| Return | Net Income from Total Operations for the last 12 months divided |
| on | by the most recent Total Assets, expressed as a percentage. |
| Assets | |
| Return | Net Income from Total Operations for the last 12 months divided |
| on | by the most recent quarter's Common Equity expressed as a |
| Equity | percentage. |
| Profit | Net Income from Total Operations for the last 12 months divided |
| Margin | by the Revenues from the last 12 months, expressed as a |
| | percentage. |
| Current | Total Assets from the most recent quarter divided by Total |
| Ratio | Liabilities from the most recent quarter. |
| Debt to | Long-Term Debt from the most recent quarter divided by |
| Equity | Common Equity from the most recent quarter. |

Earnings

The earnings parameters provide both current and projected earnings. Examples of specific equity parameters are as follows:

| | |
|---|---|
| Current | The earnings per share from total operations continuing |
| Earnings | operations plus discontinued operations) are taken from the |
| | corporation's 10-K, l0-Q, or preliminary statements. |
| This Year | Analysts' Mean estimated per share for the current year |
| | along with the high and low analysts' estimates. |
| Next Year | Analysts' Mean estimated per share for the next year along |
| | with the high and low analysts' estimates. |
| Growth | Estimated earnings growth for the current year, expressed |
| This Year | as a percentage. |
| Growth | Estimated earnings growth for the next year, expressed as a |
| Next Year | percentage. |
| Growth | Long-term estimated earnings growth, expressed as a |
| Next 5 | percentage. |
| Years | |
| Growth | Compound annual growth rate of EPS for the last 5 years, |
| Last 5 | expressed as a percentage. |
| Years | |

Ratios

The Ratios parameters, such as price-to-earnings (P/E) and price-to-book (P/B), are often used to assess the relative value of an equity. Examples of specific equity parameters are as follows:

| | |
|---|---|
| P/E | The price-to-earnings ratio is the latest closing price divided by the |
| | earnings per share based on the last 4 quarters of earnings. |
| P/B | The price-to-book ratio is the latest closing price divided by the |
| | most recent quarter common equity, or book value, per share. |
| P/S | The latest closing price divided by the sales per share based on the |
| | last 4 quarters. |
| PEG | The price-to-earnings ratio divided by the 3-year average projected |
| | growth rate |

Valuation

The valuation parameters provide valuations for a given equity using a variety of valuation techniques. The ratio of price to these valuation techniques yields a ratio which can be used to compare equities with different prices (Oust as, for example, P/E is used).

Equity valuation is the process of assigning a dollar value to a given equity. An ideal equity valuation technique would assign an accurate dollar value to all equities. If a trader purchased a given equity when it traded below its value, the equity price would gradually rise to the “correct” price at which time the trader would sell the equity and then proceed to buy the next bargain on the list. Valuation models can provide a basis with which to compare the relative merits of two different equities. Some valuation models have been shown statistically to provide above-market average returns when “undervalued” equities are purchased.

A plethora of models exists to value equities. These models range from relatively simplistic rules of thumb to complex models which extrapolate an equity value from multiple years of earnings estimates.

User Input

As discussed previously, equity screening in accordance with the present invention is based upon the rankings which are preferably derived for each parameter of every equity in a given pool of equities. For example, if the user wants low P/E equities, the present invention finds those equities which have the best (i.e., lowest) P/E ranking. If the user preferences require equities having a high six-month price gain, then the present invention will return equities having the best blend of both low P/E and high six-month price gain.

Instead of indicating specific P/E or price gain ranges, a user need simply indicate his preferences for these parameters via a user input form, and the present invention will perform the screening analysis. However, an additional aspect of the present invention is that the user may designate specific ranges for parameters in an “Advanced” user input form, if desired.

The screening method of the present invention can return equities that have the best blend of parameters specified by the user's input. For example, if the user wishes to obtain “undervalued equities with high earnings growth, high six-month price change, and high analysts' ratings,” he would not necessarily see equities with as high a six-month price change as he would if he screened for just the “high six-month price change” without any other restrictions. This variation lends the present invention to varied input formulations.

The present invention supports basic and advanced user input forms. With the basic user input forms, the user is limited to a certain subset of parameters within the database, whereas with an advanced user input form, the user may screen based upon any data within the database. The basic user input forms automatically set defaults for the user. However, a user may switch from a Basic to an Advanced user input form at any time.

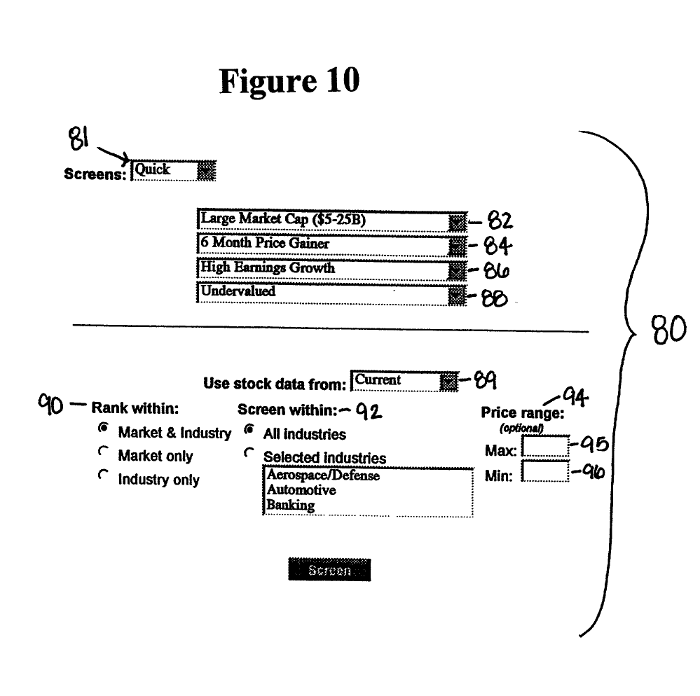

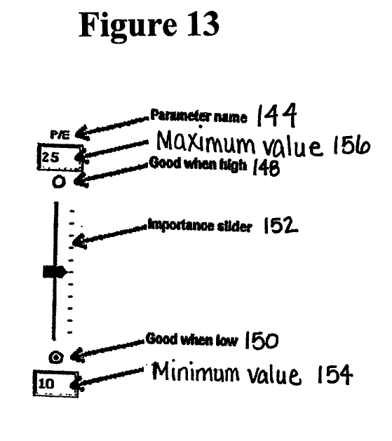

FIGS. 10-13 depict exemplary user input forms for the present invention. Each embodiment of the user input form is discussed in detail below. Those skilled in the art will recognize that FIGS. 10-12 may be used in connection with any of the embodiments of the present invention depicted in FIGS. 1-5. FIG. 13 is adapted for use with the embodiment depicted in FIG. 6.

Quick User Input

The Quick User Input form 80, one type of Basic User Input form, contains default settings (example shown in FIG. 10). To use the Quick User Input form, the user selects “Quick” in the “Screens” field 81. These user input settings assist in finding undervalued Large Capitalization companies with high earnings growth whose price has increased over the previous six months.

Preferably, in this embodiment, the user can choose from the following categories of market capitalization in the “Market Capitalization” section 82:

1. Any

2. Giant Market Capitalization (>$25B)

3. Large Market Capitalization ($5-25B)

4. Medium Market Capitalization ($1-5B)

5. Small Market Capitalization ($0.25-1B)

6. Micro Market Capitalization (<$250M)

The user can choose from the following price changes in the “Price Momentum” section 84:

1. Any

2. Six-Month Price Gainer

3. Six-Month Price Loser

The user can choose from the following categories of earnings growth in the “Earnings Growth” section 86:

1. Any

2. High Earnings Growth

3. Low Earnings Growth

The user can also choose from the following valuations in the “Valuation” section 88:

1. Any

2. Undervalued

3. Overvalued

In the “Use stock data from” section 89, the user may select to choose stock data from the current time period or from previous time periods, e.g., one month ago, three months ago, or six months ago. In the “Rank within” section 90 the user may choose to rank the equities within the entire market, within the industry, and as a combination of both. This ranking is performed by comparing values for each parameter (e.g., P/E, etc.) and then ranking each equity according to its parameter value from highest to lowest. The ranking is done 1) within an industry, 2) within the market as a whole, and 3) within market and industry, which is a blend of the market rank and the industry rank. In the “Screen within” section 92, it is preferable to allow selections either within all industries, or within certain industries, such as the following:

1. Aerospace/Defense

2. Automotive

3. Banking

4. Chemicals

5. Computer Hardware

6. Computer Software & Services

7. Conglomerates

8. Consumer Durables

9. Consumer Non-Durables

10. Diversified Services

11. Drugs

12. Electronics

13. Energy

14. Financial Services

15. Food & Beverage

16. Health Services

17. Insurance

18. Internet

19. Leisure

20. Manufacturing

21. Materials & Construction

22. Media

23. Metals and Mining

24. Real Estate

25. Retail

26. Specialty Retail

27. Telecommunications

28. Tobacco

29. Transportation

30. Utilities

31. Wholesale

The user may select, if desired, more than one of the above industry categories. The user may optionally enter a minimum and/or a maximum price into the search criteria in the “Price range” section 94.

In a computer embodiment of the present invention, it is preferable to utilize pulldown menus for these user input choices (for example, in HTML, using the “form” command for the input, with the use of the “select” command for the category, and the “option” command being the various choices).

The Quick User Input form can be translated into Advanced User Input form. The Advanced User Input form settings are as follows:

“Market Capitalization” sets a minimum and maximum limit to the specified market capitalization range.

“Price Gainer” (1) sets the minimum six-month price momentum to 1.0 signifying that the price is at least equal to the price six months ago, and (2) weights the screen results in favor of price gains. The “Price Loser” does the opposite.

“High Earnings Growth” weights the screen results in favor of high earnings growth rates, based upon the percent earnings growth this year, percent earnings growth next year, and long term earnings growth. Furthermore, “Low Earnings Growth” weights the screen in favor of equities with low earnings growth rates.

“Undervalued” weights the screen results in favor of undervalued equities, or equities with a low price/value ratio, based upon the average equity valuation. The “Overvalued” selection is weighted in favor of high price/value equities.

No weighting will be applied to a parameter if “Any” is selected.

The present invention allows the user to select whether the results of the screen will represent the “best” equities within the market as a whole (Market only), within their individual industry groups (Industry only), or both (Market and Industry).

The present invention also allows the user to select which industries will be used for the equity screening. For example, the default may be “All industries,” but the user may choose one or more specific industry groups to screen within.

The minimum and maximum price fields are used to filter out equities which are trading in a price range that is too low or too high for the user's investment style.

Standard User Input

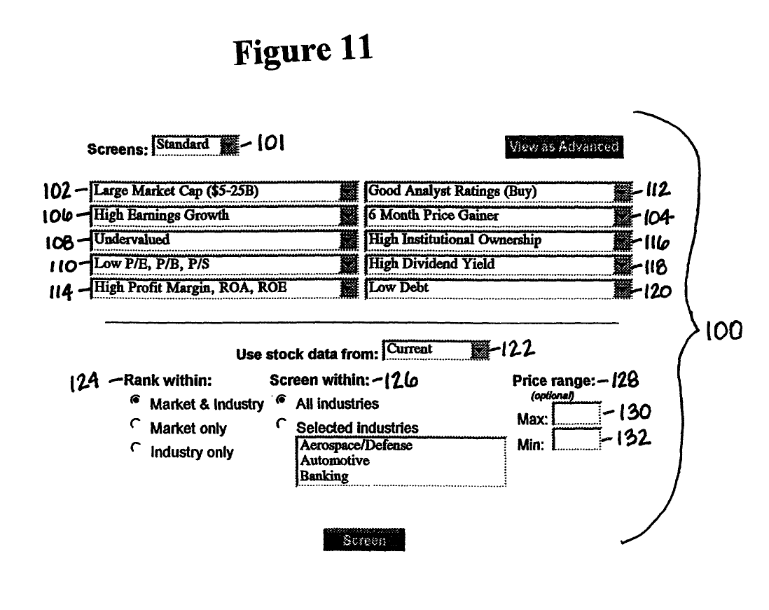

An example of a Standard User Input form 100 is shown in FIG. 11. The Standard User Input form, another type of basic user input form, is like the Quick User Input form, but offers more user input selections. To use the Standard User Input form, the user selects “Standard” in the “Screens” field 101. In addition to Market Capitalization 102, Price Momentum 104, Earnings Growth and Valuation 106, the Standard User Input form can be used to select equities based upon Ratios 110 (P/E, P/B, etc.), Analysts' ratings 112, Profitability 114, Institutional Ownership 116, Dividend Yield 118, and Debt 120.

Set forth below are the screening parameters that are available within the Standard User Input form.

“Market Capitalization” sets a minimum and maximum limit to the specified market capitalization range. A user may select from the following categories of market capitalization:

7. Any

8. Giant Market Capitalization (>$25B)

9. Large Market Capitalization ($5-25B)

10. Medium Market Capitalization ($1-5B)

11. Small Market Capitalization ($0.25-1B)

12. Micro Market Capitalization (<$250M)

“High Earnings Growth” weights the screen results in favor of high earnings growth rates, based upon the percent earnings growth this year, percent earnings growth next year, and long term earnings growth. “Low Earnings Growth” weights the screen in favor of equities with low earnings growth rates. A user may alternatively select “Any” if he has no preference with respect to earnings growth.

“Undervalued” weights the screen results in favor of undervalued equities (equities with a low price/value ratio) based upon the average equity valuation. “Overvalued” weights in favor of high price/value equity. A user may alternatively select “Any” if he has no preference with respect to valuation.

“Low P/E, P/B, P/S” weights the screen results in favor of equities with low price-to-earnings, price-to-book and price-to-sales ratios. A user may alternatively select “High P/E, P/B, P/S” (opposite of “Low”) or “Any” (no preference).

“High Profit Margin, ROA, ROE” weights the screen in favor of equities which have high profit margin, return on assets, and return on equity. These items are traditional measures of profitability and management effectiveness. A user may alternatively select “Low Profit Margin, ROA, ROE” (opposite of “High”) or “Any” (no preference).

“Good Analyst Ratings (Buy)” weights the screen in favor of equities which have high analysts' ratings. “Bad Analyst Ratings (Sell)” has the opposite weighting. A user may alternatively select “Any” if he has no preference with respect to Analyst Ratings.

“Six-Month Price Gainer” (1) sets the minimum six-month price momentum to 1.0 (price is at least equal to price six-months ago) and (2) weights the screen results in favor of price gains. The six-month “Price Loser” does the opposite. Alternatively, a user may select “Any” if he has no preference.

“High Institutional Ownership” weights the screen in favor of equities with a high percent of institutional ownership. Alternatively, a user may select “Low Institutional Ownership” (opposite of “High”) or “Any” (no preference).

“High Dividend Yield” weights the screen in favor of equities with a high dividend yield. Alternatively, a user may select “Low Dividend Yield” (opposite of “High”) or “Any” (no preference).

“Low Debt” weights the screen in favor of equities with a low debt-to-equity ratio. Alternatively, a user may select “High Debt” (opposite of “Low”) or “Any” (no preference).

Within each parameter, no weighting will be applied to a parameter with “Any” selected. “Any” should be selected when a user does not care about a particular parameter.

In the “Use Stock data form” section 122, the present invention allows the user to use stock data from the current time period or from previous time periods, e.g., 1, 3, or 6 months ago. Furthermore, the “Rank within” section 124 allows the user to select whether the results of the screening will represent the “best” equities within the market as a whole (Market only), within their individual industry groups (Industry only), or both (Market and Industry).

The “Screen within” section 126 allows the user to select which industries will be used for the equity screen. For example, the default may be “All industries,” but the user may choose one or more specific industry groups to screen within.

In the “Price Range” section 128, the maximum 130 and minimum 132 price fields are used to filter out equities which are trading in a price range that is too low or too high for the user's investment style.

The user input options represent weightings as opposed to assurances of features on an individual equity. For example, when using a Standard User Input form, the user will obtain equities which offer the best blend of the screening parameters. Some equities that have low analysts' ratings may show up in the screening results, but this is because other parameters were ranked higher (e.g., price gain, profitability, etc.) than the analysts' ratings. A user may alternatively select “any” if he has no preference with respect to earnings growth.

If a user selects “Any” for more than one parameter, the other parameters have a higher weight. It is best not to assign any weighting to parameters that the user does not care about.

Advanced User Input

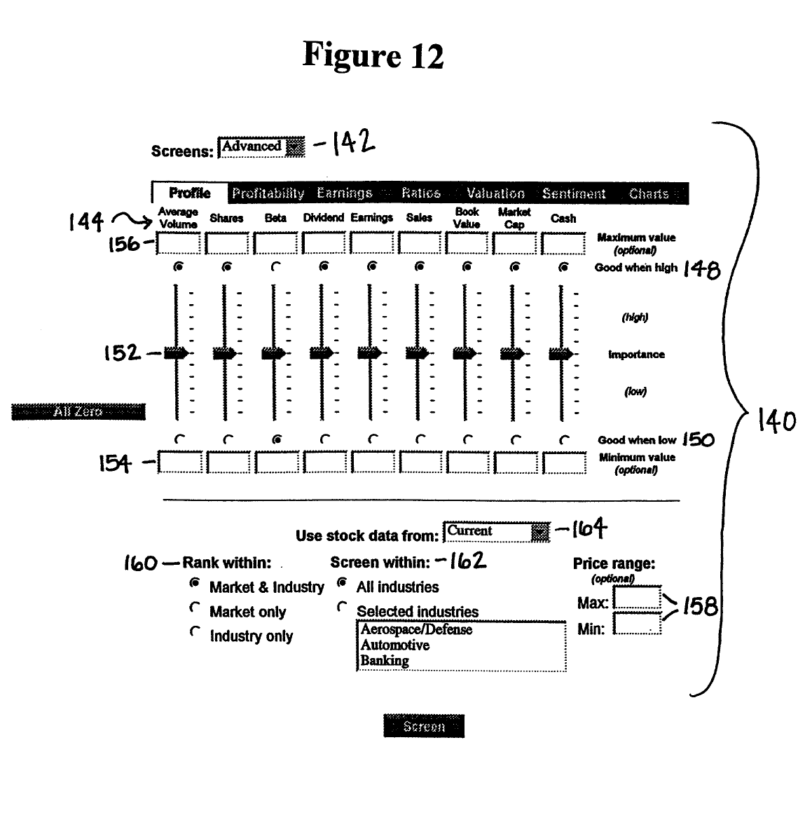

The Advanced User Input form is the most powerful and versatile input form for entering user preferences embodied in the present invention. FIG. 12 shows an example of an Advanced User Input form 140. To choose this user input form, the user selects “Advanced” in the “Screens” field 142. With the Advanced User Input form, the user can select equities based upon the ranking of all of the parameters 144 in the database; choose whether the screening method should weigh high or low values of each equity's parameter by selecting the “Good when high” button 148 or the “Good when low” button 150; use slider bars 152 to assign an importance from 0 (low importance) to 10 (high importance) for each equity parameter; enter a minimum value 154 and/or a maximum value 156 for each equity parameter; choose minimum and/or maximum allowable prices for equities within the screening results in the “Price range” fields 158, and choose whether to screen equities by market-based ranking, industry-based ranking, or both in the “Rank within” field 160. The “Screen within” 162, “Use stock data from” 164, “Rank within” field 160, and “Price range” 158 fields are the same as those previously discussed in the Quick, Standard, and Similar User Input forms.

The best way to describe the setup of a screening parameter is by example. The discussion of the P/E slider by way of example applies equally well to all of the screening parameters.

As seen in FIGS. 12 and 13, there are multiple options for each parameter. In FIGS. 12 and 13, the parameter name 144 is the name of the screening parameter (P/E, in this example).

“Maximum Value” 156 is an optional text field where the user can enter the maximum allowable value for a given parameter (in FIG. 13, P/E is limited to 25).

The “Good when high” selection 148 tells the screening algorithm to assign a “good” weighting to equities which a have high value for this parameter.

The importance slider 152 assigns an importance to this parameter. If the slider is at its minimum position, the parameter will not affect the screening results. If the slider is at the maximum position, this parameter will have a heavy weighting on the screening results.

The “Good when low” selection 150 tells the screening algorithm to assign a “good” weighting to equities which have a low value for this parameter.

“Minimum Value” 154 is an optional text field where the user can enter the minimum allowable value for a given parameter (in FIG. 13, P/E must be at least 10).

“Good When High”/“Good When Low” Settings:

In order to rank a parameter, either “Good when high” or “Good when low” must be selected. This tells the screening algorithm the user's personal investing preference for each equity parameter. For example, value investors typically seek out equities with low P/E, P/B, and P/S ratios, relative to other equities. As shown in FIG. 13, the default setting for P/E is “Good When Low” in order to see relatively low P/E equities. If a user's investing style involves finding high P/E equities, he should select “Good When High.”

Importance Slider:

Once the user has told the screening algorithm whether he would like a parameter to be high or low, he can then specify the importance of the parameter using the “Importance Slider.” If for example, he really cares about P/E, he should set the slider to 10. If he does not care about P/E at all, the slider should be set to zero.

Minimum and Maximum Values:

The minimum and maximum value fields are optional. The slider in this example will force the screening algorithm to eliminate every equity from the screening results that does not have a P/E between 10 and 25. This may also eliminate numerous equities which might be suitable for the user's investing style, but which have slightly higher or lower P/E ratios, so it is best to use these limits only if the user's investment strategy actually imposes limits upon certain parameters.

An example of the appropriate usage of the “Minimum Value” and “Maximum Value” fields is when the user is screening for equities within a given Market Capitalization range. It may also be useful to set the six-month Price Momentum to a minimum value of 1.0; this forces the screening algorithm to return only equities that have increased or maintained the same price over the last six months.

In summary, the Advanced User Input form is set up using individualized settings for each parameter in the database. These parameter settings allow the user to tell the screening algorithm whether the parameter should be high or low. These settings also tell the screening algorithm how important the user considers the parameter to be and assigns minimum and maximum allowable values for each parameter.

Similar Screen User Input

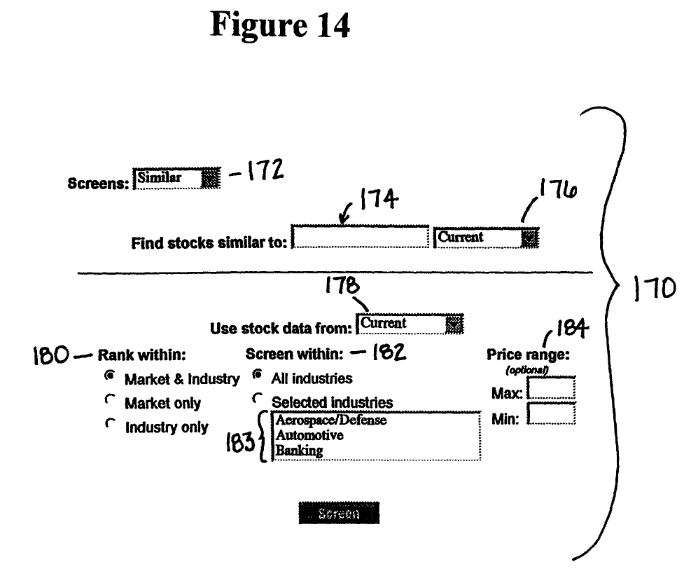

The Similar Screen User Input form 170 is depicted in FIG. 14. This user input form is used in order to screen equities that are similar to other equities (i.e., target equities) from the current or historical data. To choose this user input form, the user selects “Similar” in the “Screens” field 172. The user inputs a target equity into the “Find stocks similar to” field 174 and inputs the preferred time period (current or previous, e.g., 1, 3, or 6 months ago) for the target equity in the adjacent time period field 176. For the stock data to screen from, the user may select to choose stock data from the current time period or from previous time periods, (e.g., 1, 3, or 6 months ago) in the “Use Stock data from” field 178. In the “Rank within” section 180, the user may choose to rank the equities within the market only, the industry only, or within the market and industry. In the “Screen within” section 182, the user may select “All industries” or one or more specific industries from the list provided 183. The user may optionally enter a minimum and/or a maximum price into the search criteria in the “Price range” section 184.

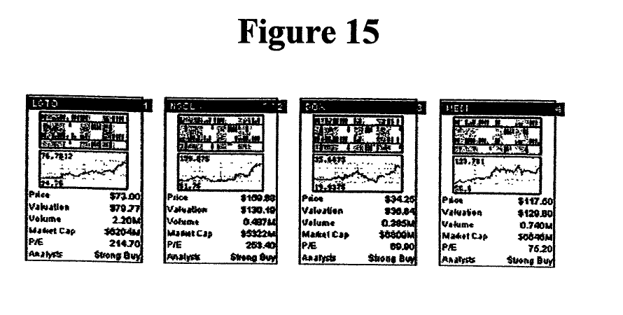

Following the equity screening analysis, the top results (number of results determined by user) are displayed as the “best” matches in the market per the user's request. These equities represent the best blend of all of the parameters according to the user's ranking and weighting. In this embodiment, over 8000 equities for the parameters described above may be searched. A typical “results” screen is shown in FIG. 15.

It will be apparent to those skilled in the art that various modifications and variations can be made to the present invention without departing from the spirit and scope of the invention. For example, although the present invention has been shown and described with reference to these preferred embodiments, the present invention is equally applicable to embodiments employing different ranking algorithms and methodology. In addition, the method steps claimed for each of the above-described embodiments of the present invention may be practiced in more than one order. Accordingly, the claims are in no way intended to be limited to the sequence of steps as they appear in the appended claims. Thus is it intended that the present invention cover the modifications and variations of this invention provided they come within the scope of the appended claims and their equivalents.

What is claimed is:

1. A method of equity screening, said method comprising the steps of:
receiving a pool of equities wherein said equities include a plurality of parameters;
assigning a parameter ranking to each parameter of said plurality of parameters;
receiving a plurality of user preferences for parameters of interest;
selecting a weighting function for each parameter of interest;
assigning a score to each equity based on said weighting function and said parameter ranking; and
selecting at least one equity meeting the user's preferences.

2. The method of claim 1 wherein said step of assigning a parameter ranking includes the step of ranking all equities within an industry group.

3. The method of claim 1 wherein said selecting step includes the steps of choosing equities having scores from high to low and picking top “n” scoring equities.

4. The method of claim 1 further comprising the step of displaying said at least one equity.

5. The method of claim 1 further comprising the steps of selecting a parameter range and disallowing one or more of equities from said pool of equities based on the parameter range.

6. The method of claim 1 wherein said ranking of said parameter values is based on the formula:
$$\frac{parameter - \text{average parameter value}}{standard deviation of parameter}$$
wherein said average and said standard deviation values are derived from a market as a whole.

7. The method of claim 1 wherein said ranking of said parameter values is based on the formula:
$$\frac{parameter - average parameter value}{standard deviation of parameter}$$
wherein said average and said standard deviation values are derived from a subgroup of a market as a whole.

8. The method of claim 1 further comprising the step of applying a data filter to said pool of equities after the step of receiving said pool of equities.

9. The method of claim 1 further comprising the step of applying a group filter to said pool of equities after the step of receiving said pool of equities.

10. A method of similar equity screening comprising:
selecting one or more target equities from a pool of equities;
providing a pool of equities wherein said equities have one or more parameters;
collect parameters for the target equity;
assigning a parameter ranking to each said parameter;
selecting a weighting function for each said parameter based on said target equity;
assigning a score to each equity based on said weighting function and said parameter ranking; and
selecting at least one equity representative said target equity.

11. The method of claim 10 wherein said weighting is within each said equity's industry group.

12. The method of claim 10 wherein said weighting is within a market as a whole.

13. The method of claim 10 wherein said weighting is within each said equity's industry and within a market as a whole.

14. The method of claim 10 further comprising the step of displaying said at least one equity.

15. The method of claim 10 further comprising selecting a parameter range; and disallowing a portion of equities from said pool of equities based on said parameter range.

16. The method of claim 10 further comprising disallowing a portion of equities from said pool of equities based on a grouping.

17. The method of claim 10 further comprising disallowing a portion of equities from said pool of equities based on an industry.

18. The method of claim 10 wherein said ranking of said parameter values is based on the formula:
$$\frac{parameter \text{-} average parameter value}{standard deviation of parameter}$$
and wherein said average and said standard deviation values are derived from a market as a whole.

19. The method of claim 10 wherein said ranking of said parameter values is based on the formula:
$$\frac{parameter \text{-} average parameter value}{standard deviation of parameter}$$
and wherein said average and said standard deviation values are derived from a subgroup of a market as a whole.

20. The method of claim 10 further comprising the step of back testing.

21. A method of screening equities, said method comprising the steps of:
ranking a plurality of equity parameters to normalize each equity parameter with respect to each other equity parameter;
receiving user preferences respecting the weight to be given equity parameters of interest;
weighting the ranked equity parameters of interest based upon the received user preferences to assign each equity a score; and
selecting at least one scored equity appropriate for the user preference.

22. A system for screening equities, said system comprising:
a server system configured to receive equity parameters for a plurality of equities and user preferences respecting the weight to be given equity parameters of interest;
a database communicating with said server system to store the received equity parameters; and
a central processing unit communicating with said database to rank the received equity parameters in order to normalize each equity parameter with respect to each other equity parameter, said central processing unit instructed to weight the ranked equity parameters of interest based upon the received user preferences in order to assign each equity a score and to select at least one scored equity appropriate for the user's preferences.
